(19) United States
(12) Patent Application Publication
(10) Pub. No.: US 2017/0126548 A1
(43) Pub. Date: May 4, 2017

(54) Electronic Device and Method

(71) Applicant: KABUSHIKI KAISHA TOSHIBA, Tokyo (JP)

(72) Inventor: Hidetoshi Yokoi, Akishima Tokyo (JP)

(73) Assignee: KABUSHIKI KAISHA TOSHIBA, Tokyo (JP)

(21) Appl. No.: 15/046,347

(22) Filed: Feb. 17, 2016

Related U.S. Application Data
(60) Provisional application No. 62/248,053, filed on Oct. 29, 2015.

(51) Int. Cl. H04L 12/725; H04W 4/00

(52) U.S. Cl. CPC H04L 45/306; H04W 4/008; H04W 88/02

(57) ABSTRACT

According to one embodiment, an electronic device includes a display device, an audio output device, a communication device and a hardware processor. The hardware processor is configured to transmit information for a notification of a second program including at least one of video and audio to an external device by use of the communication device, if the notification for a user of the electronic device with the video and the audio is performed by the second program in a state where at least one of exclusive video output from the display device and exclusive audio output from the audio output device is performed due to a first program.

### CROSS-REFERENCE TO RELATED APPLICATIONS

This application claims the benefit of U.S. Provisional Application No. 62/248,053, filed Oct. 29, 2015, the entire contents of which are incorporated herein by reference.

### FIELD

Embodiments described herein relate generally to an electronic device and a method.

### BACKGROUND

Recently, various electronic devices such as personal computers and smartphones have become widespread. The users of these types of electronic devices can use their desired software by installing them.

The software which is arbitrarily installed by each user and runs on these types of electronic devices may occupy the display function and output video or may occupy the function for outputting audio and output audio. This type of exclusive output of video and audio is called, for example, exclusive video output and exclusive audio output. The operation mode of the display portion in exclusive video output or the operation mode of the audio output portion in exclusive audio output is called, for example, an exclusive mode.

In a state where at least one of the display portion and the audio output portion is in an exclusive mode because of a piece of software, another piece of software may perform a notification for the user, in other words, message output. This message output is assumed to be performed as both video output and audio output. In this case, although the notification is performed using video and audio, one of the video and the audio may not be output, or none of them may be output. Thus, the notification may be overlooked by the user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing an example of the utility form of an electronic device according to an embodiment.

FIG. 2 is an exemplary view showing another example of the utility form of the electronic device according to the embodiment.

FIG. 3 is an exemplary view showing an example of the system configuration of the electronic device according to the embodiment.

FIG. 4 is an exemplary block diagram for explaining the function of a message notification utility program which runs on the electronic device according to the embodiment.

FIG. 5 is an exemplary view showing an example of the system configuration of an external device according to the embodiment.

FIG. 6 is an exemplary block diagram for explaining the function of a message reception utility program which runs on the external device according to the embodiment.

FIG. 7 is an exemplary view for explaining the content of a setting process performed by the message notification utility program which runs on the electronic device according to the embodiment.

FIG. 8 is an exemplary view for explaining a process for adaptively transmitting a message to the external device by the message notification utility program which runs on the electronic device according to the embodiment.

FIG. 9 is an exemplary flowchart showing the flow of message transmission to the external device by the message notification utility program which runs on the electronic device according to the embodiment.

### DETAILED DESCRIPTION

Various embodiments will be described hereinafter with reference to the accompanying drawings.

In general, according to one embodiment, an electronic device includes a display device, an audio output device, a communication device and a hardware processor. The a hardware processor is configured to transmit information for a notification of a second program including at least one of video and audio to an external device by use of the communication device, if the notification for a user of the electronic device with the video and the audio is performed by the second program in a state where at least one of exclusive video output from the display device and exclusive audio output from the audio output device is performed due to a first program.

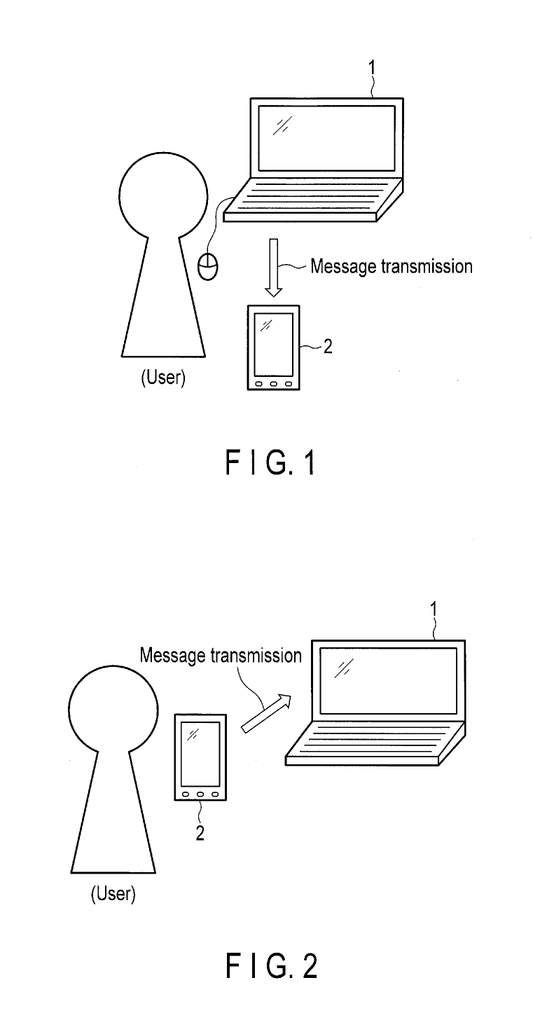

FIG. 1 is an exemplary view showing an example of the utility form of an electronic device according to an embodiment. Here, the electronic device of the present embodiment is assumed to be realized as, for example, a notebook personal computer 1. The user of the personal computer 1 is assumed to use a smartphone 2 at the same time. In a state where exclusive video output or exclusive audio output is performed because of a piece of software (program), another piece of software may perform a notification (in other words, message output) for the user of the personal computer 1, using video and audio. In this case, the personal computer 1 which is the electronic device of the present embodiment transmits the notification to the smartphone 2 which is an external device in order to cause the smartphone 2 to perform the notification in place of the personal computer 1. This point is explained in detail below.

As explained above, here, the electronic device of the present embodiment is assumed to be realized as the notebook personal computer 1. However, as shown in FIG. 2, the electronic device may be realized as the smartphone 2, and the smartphone 2 may transmit a notification to the personal computer 1 which is an external device in a predetermined state. Thus, any device can be applied to the electronic device of the present embodiment as long as the device performs at least one of exclusive video output and exclusive audio output and has a communication function.

Exclusive video output or exclusive audio output is performed when, for example, (1) software reproduces high-definition video or when (2) software performs full-screen display. Here, full-screen display does not indicate that the window in which the display screen of software is allocated is maximized on a basic screen called desktop, etc., in a state where the basic screen is drawn in the whole display area. Instead, full-screen display indicates that the display screen of software is drawn directly in the whole display area. The personal computer 1 is in an exclusive video output state or an exclusive audio output state when high-definition video is reproduced because the greater part of resources (including the portion related to video output and the portion related to audio output) is used in giving the highest priority to reproduction of the high-definition video.

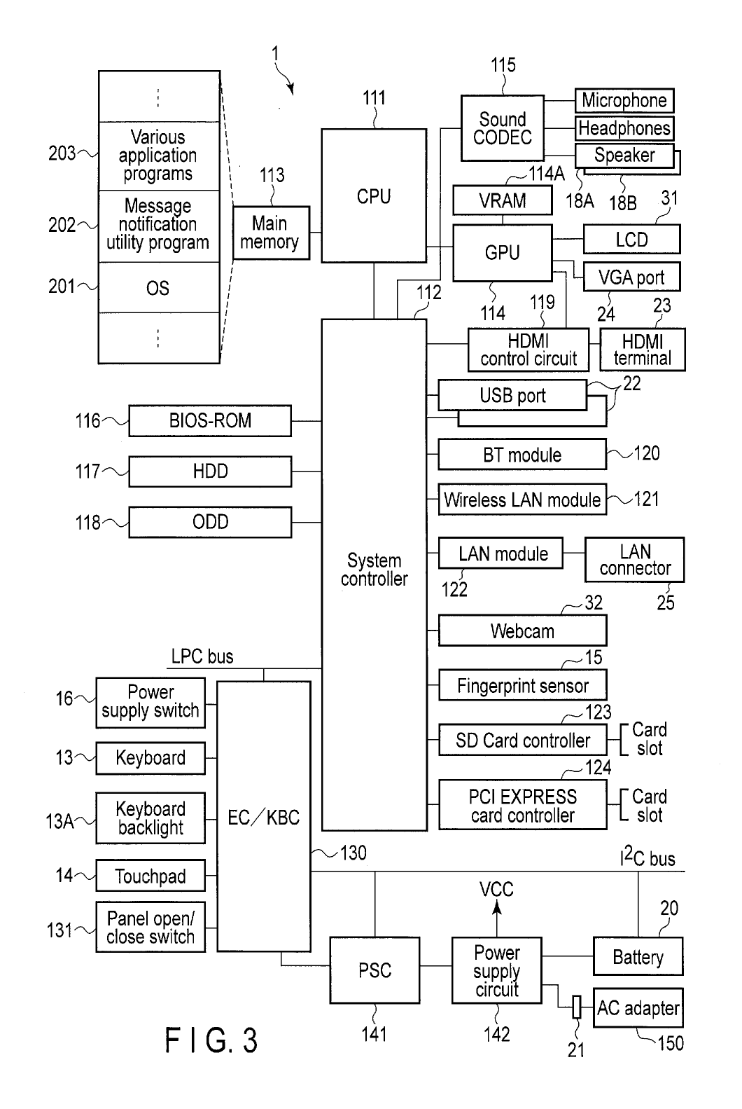

FIG. 3 is an exemplary view showing an example of the system configuration of the personal computer 1.

The personal computer 1 comprises, for example, a CPU 111, a system controller 112, a main memory 113, a graphics processing unit (GPU) 114, a sound codec 115, a BIOS-ROM 116, a hard disk drive (HDD) 117, an optical disc drive (ODD) 118, a BT (Bluetooth [registered trademark]) module 120, a wireless LAN module 121, a LAN module 122, an SD Card controller 123, a PCI EXPRESS card controller 124, an embedded controller/keyboard controller IC (EC/KBC) 130, a keyboard backlight 13A, a panel open/close switch 131, a power supply controller (PSC) 141 and a power supply circuit 142.

The CPU 111 is a processor (a hardware processor) which controls the operations of the components of the personal computer 1. The CPU 111 executes various types of software loaded from the HDD 117 to the main memory 113. The software includes an operating system (OS) 201, a message notification utility program 202 as described later and various types of application programs 203. The message notification utility program 202 is incorporated into the personal computer 1 as a resident program.

The CPU 111 also executes a Basic Input/Output System (BIOS) stored in the BIOS-ROM 116 which is a nonvolatile memory. The BIOS is a system program for hardware control.

The GPU 114 is a display controller which controls an LCD 31. The GPU 114 generates a display signal (LVDS signal) to be supplied to the LCD 31 from display data stored in a video memory (VRAM) 114A. The GPU 114 is also capable of generating an analog RGB signal and an HDMI video signal from the display data. An analog RGB signal is supplied to an external display device via a VGA port 24. An HDMI output terminal 23 is capable of transmitting an HDMI video signal (uncompressed digital video signal) and a digital audio signal to an external display through one cable. An HDMI control circuit 119 is an interface for transmitting an HDMI video signal and a digital audio signal to an external display device via the HDMI output terminal 23.

The sound codec 115 is a sound controller which performs an audio process for audio input from a microphone and audio output to headphones or a speaker.

The BT module 120 is a communication device which performs wireless communication conforming to the Bluetooth (registered trademark) standard. The wireless LAN module 121 is a communication device which performs wireless communication conforming to, for example, the IEEE 802.11 standard. The LAN module 122 is a communication device which performs wire communication conforming to, for example, the IEEE 802.3 standard.

The system controller 112 is a bridge device which connects the CPU 111 and each component. The system controller 112 comprises a built-in Serial ATA controller for controlling the hard disk drive (HDD) 117 and the optical disc drive (ODD) 118. Further, the system controller 112 communicates with each device on a Low Pin Count (LPC) bus.

The EC/KBC 130 is connected to the LPC bus. The EC/KBC 130, the power supply controller (PSC) 141 and a battery 20 are connected mutually via a serial bus such as an I²C bus.

The EC/KBC 130 is a power management controller for managing the power of the personal computer 1 and is realized as a single-chip microcomputer comprising a built-in keyboard controller which controls a keyboard (KB) 13, a touchpad 14, etc. The EC/KBC 130 has a function for powering on and off the personal computer 1 in accordance with the user's operation of a power supply switch 16. The control of powering on and off the personal computer 1 is performed by the cooperation between the EC/KBC 130 and the power supply controller (PSC) 141. When the power supply controller (PSC) 141 receives an on-signal from the EC/KBC 130, the power supply controller (PSC) 141 powers on the personal computer 1 by controlling the power supply circuit 142. When the power supply controller (PSC) 141 receives an off-signal from the EC/KBC 130, the power supply controller (PSC) 141 powers off the personal computer 1 by controlling the power supply circuit 142. The EC/KBC 130, the power supply controller (PSC) 141 and the power supply circuit 142 are operated by the power from the battery 20 or an AC adapter 150 even while the personal computer 1 is powered off.

Further, the EC/KBC 130 is capable of powering on/off the keyboard backlight 13A provided on the back side of the keyboard 13. The EC/KBC 130 is connected to the panel open/close switch 131 configured to detect the opening and closing of the display unit into which the LCD 31 is incorporated. When the opening of the display unit is detected by the panel open/close switch 131, the EC/KBC 130 is also capable of powering on the personal computer 1.

The power supply circuit 142 generates power (operation power source) to be supplied to each component, using the power from the battery 20 or the AC adapter 150.

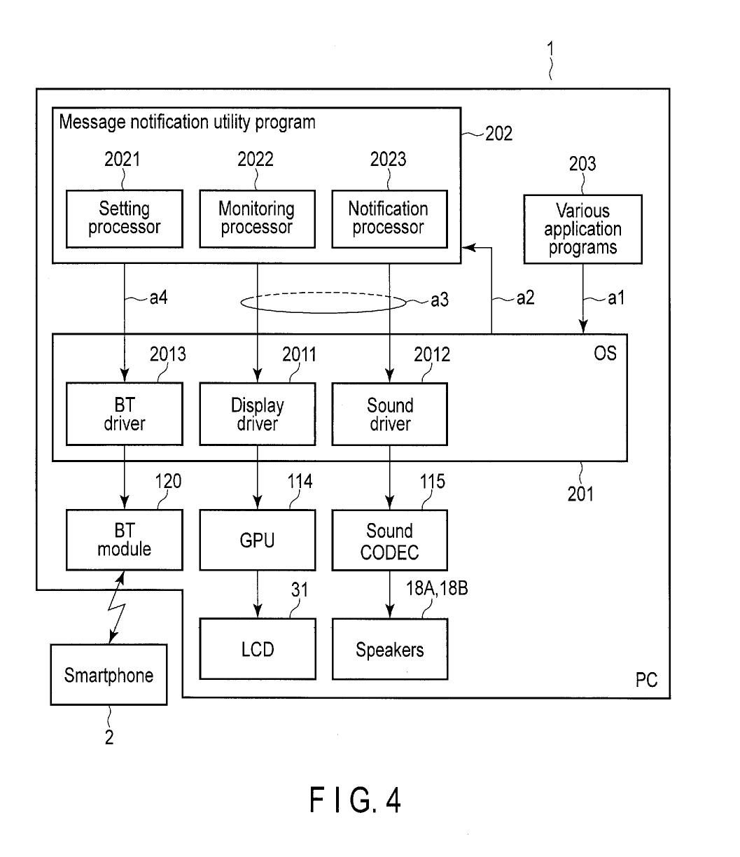

Now, this specification explains the function of the message notification utility program 202 running on the personal computer 1 having the above system configuration, referring to FIG. 4.

As shown in FIG. 4, the message notification utility program 202 comprises a setting processor 2021, a monitoring processor 2022 and a notification processor 2023. For transmitting a notification for the user of the personal computer 1 by various application programs 203 to the smartphone 2, the setting processor 2021 performs setting for adaptively determining the transmission target from the video and audio used for the notification. The monitoring processor 2022 performs monitoring for determining whether or not the personal computer 1 is in an exclusive video output state and whether or not the personal computer 1 is in an exclusive audio output state when a notification for the user of the personal computer 1 is generated by various application programs 203. Based on the setting by the setting processor 2021 and the determination by the monitoring processor 2022, the notification processor 2023 transmits the notification for the user of the personal computer 1 by various application programs 203 to the smartphone 2.

Here, it is assumed that the notification for the user of the personal computer 1 by various application programs 203 is directly transmitted to the smartphone 2 through wireless communication conforming to the Bluetooth (registered trademark) standard. This transmission may be performed via the Internet by use of, for example, e-mail. Other various methods may be employed for the transmission of the notification from the personal computer 1 to the smartphone 2.

Now, this specification assumes that, in a state where one (a first program) of the application programs 203 reproduces high-definition video, another application program (a second program) performs a notification for the user of the personal computer 1. This notification is message output using video and audio.

In this case, first, the second program requests the OS 201 to output a message (a1 in FIG. 4). At this time, the OS 201 notifies the message notification utility program 202 of the request for the output of a message (a2 in FIG. 4). The message notification utility program 202 requests the OS 201 in advance to notify the message notification utility program 202 of the request for the output of a message from various application programs 203 when various application programs 203 request the output of a message.

In the message notification utility program 202 which received the notification, the monitoring processor 2022 obtains information indicating the video output state from a display driver 2011 of the OS 201 and obtains information indicating the audio output state from a sound driver 2012 of the OS 201 (a3 in FIG. 4). The display driver 2011 is a program for controlling the GPU 114. The sound driver 2012 is a program for controlling the sound codec 115.

As described above, when high-definition video is reproduced, exclusive video output is performed in the GPU 114 and the LCD 31, and exclusive audio output is performed in the sound codec 115 and speakers 18A and 18B. Based on the information obtained from the display driver 2011 and the information obtained from the sound driver 2012, the monitoring processor 2022 determines that the personal computer 1 is in an exclusive video output state and in an exclusive audio output state. The information which indicates the video output state and is obtained from the display driver 2011 may indicate, for example, whether or not the state is an exclusive video output state, indicate the state in which high-definition video is currently reproduced, or indicate the state in which full-screen display is currently applied. Similarly, the information which indicates the audio output state and is obtained from the sound codec 115 may indicate whether or not the state is in an exclusive audio output state, or indicate whether or not a specific audio output process is currently performed.

When the monitoring processor 2022 determines that the personal computer 1 is in at least one of the exclusive video output state and the exclusive audio output state, the notification processor 2023 transmits the message of the second program for the user to the smartphone 2 via a BT (Bluetooth [registered trademark]) driver 2013 of the OS 201 based on the setting by the setting processor 2021 (a4 in FIG. 4). The BT driver 2013 is a program for controlling the Bluetooth module 120. The setting by the setting processor 2021 is explained later. For example, the notification processor 2023 is capable of obtaining the video and audio of the message requested to be output from various application programs 203 by requesting the OS 201 to attach information indicating the area of the main memory 113 in which the message is stored at the time of the request for the above notification. The notification processor 2023 may obtain the video and audio of the message from the OS 201 every time the transmission to the smartphone 2 is needed. The notification processor 2023 prepares a message for the smartphone 2 to cause the smartphone 2 to output the obtained video and audio, and transmits the message to the smartphone 2.

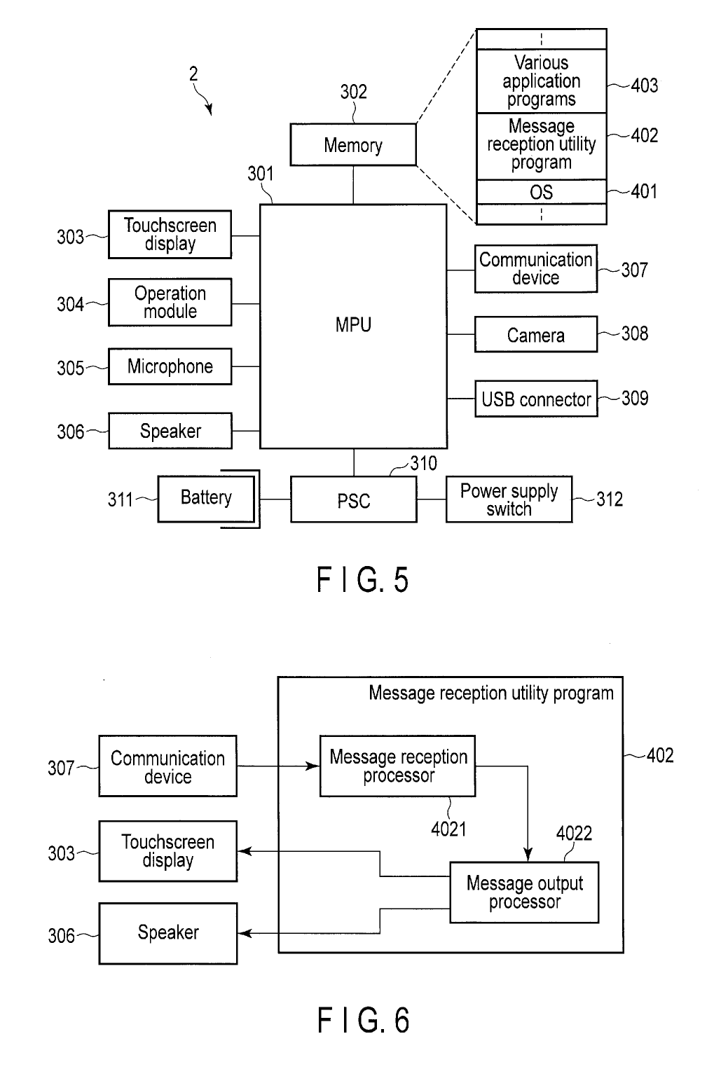

FIG. 5 is an exemplary view showing an example of the system configuration of the smartphone 2.

The smartphone 2 comprises an MPU 301, a memory 302, a touchscreen display 303, an operation module 304, a microphone 305, a speaker 306, a communication device 307, a camera 308, a USB connector 309, a PSC 310, a battery 311, a power supply switch 312, etc. The battery 311 is detachably accommodated in the housing of the smartphone 2.

The MPU 301 is a processor (a hardware processor) which controls the operation of the smartphone 2. The MPU 301 executes various types of software stored in the memory 302, such as an OS 401, a message reception utility program 402 as described later and various application programs 403. The MPU 301 comprises a built-in graphics controller which performs video display for the touchscreen display 303. The MPU 301 comprises a built-in input controller for receiving a touch operation on the touchscreen display 303 or the operation of the operation module 304. The display screen of various types of software executed by the MPU 301 is displayed on the touchscreen display 303. When a touch operation on the touchscreen display 303 or the operation of the operation module 304 is performed for the display screen, information related to the operation is supplied to the software which outputs the display screen.

The MPU 301 comprises a built-in sound controller which performs an audio process for audio input from the microphone 305 and audio output to the speaker 306.

The communication device 307 performs wireless communication conforming to, for example, the Bluetooth (registered trademark) standard. The smartphone 2 further comprises a communication module which performs communication for call although the module is not shown in FIG. 5. Further, various communication modules such as a communication module which performs wireless communication conforming to the IEEE 802.11 standard may be provided. A part of or all of these communication functions may be accommodated in the MPU 301.

The USB connector 309 is a connector capable of connecting a USB device (or a USB cable). The MPU 301 comprises a built-in USE controller which communicates with a USB device connected through the USB connector 309. The smartphone 2 is capable of inputting power through the USB connector 309. The power input from the USB connector 309 is supplied to the PSC 310.

The PSC 310 manages the power of the smartphone 2. The PSC 310 performs control for supplying the power of the battery 311 to various components of the electronic device 1. When power is input from the USB connector 309, the PSC 310 supplies the power input from the USB connector 309 to various components of the smartphone 2. The PSC 310 has a function for charging the battery 311 with the power input from the USB connector 309. Further, the PSC 310 has a function for powering on/off the smartphone 2 in response to the operation of the power supply switch 312

Now, this specification explains the function of the message reception utility program 402 which runs on the smartphone 2 having the above system configuration, referring to FIG. 6.

As shown in FIG. 6, the message reception utility program 402 comprises a message reception processor 4021 and a message output processor 4022. The message reception processor 4021 performs a process for receiving a notification (message) of various application programs 203 running on the personal computer 1 for the user. The notification is transmitted from the personal computer 1. The message output processor 4022 performs a process for outputting the video included in the message received by the message reception processor 4021 to the touchscreen display 303 and outputting the audio included in the message to the speaker 306.

Even in a state where the personal computer 1 is in an exclusive video output state and an exclusive audio output state as one (the first program) of various application programs 203 reproduces high-definition video, a notification for the user of the personal computer 1 by another application program (the second program) is performed by the smartphone 2 in place of the personal computer 1. In other words, the notification for the user can be assuredly realized.

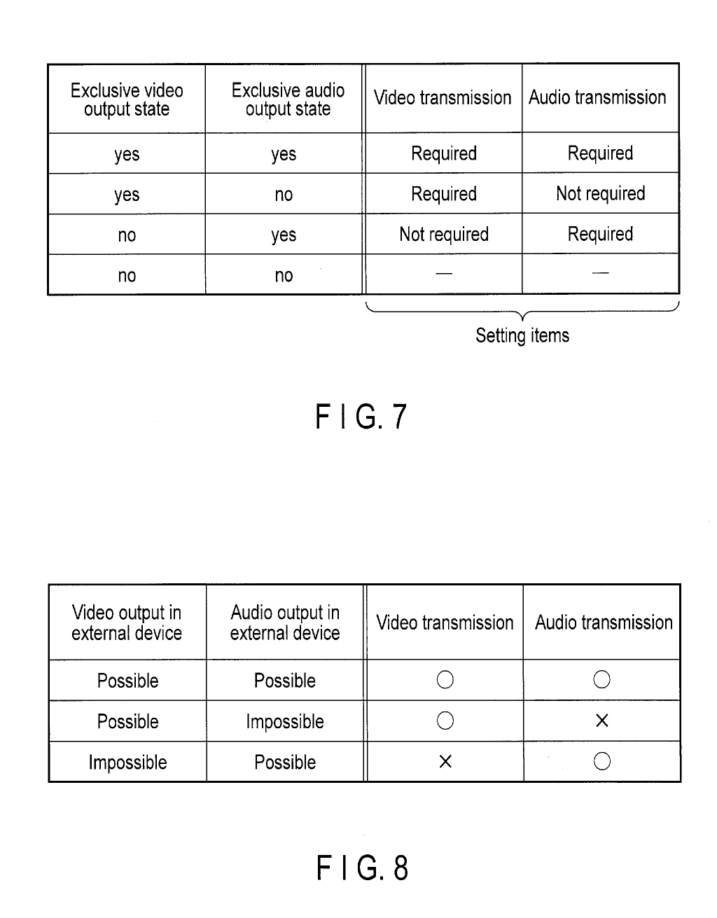

Now, this specification explains the content of the setting process performed by the setting processor 2021 of the message notification utility program 202 with reference to FIG. 7.

As the cases where a notification for the user by various application programs 203 running on the personal computer 1 is performed by the smartphone 2 in place of the personal computer 1, the following three cases are considered. (1) The personal computer 1 is in an exclusive video output state and an exclusive audio output state. (2) The personal computer 1 is in an exclusive video output state (and is not in an exclusive audio output state). (3) The personal computer 1 is in an exclusive audio output state (and is not in an exclusive video output state).

For example, in case (2), out of the video and audio used for the notification for the user by various application programs 203 (other than the program which is the cause of the exclusive video output state), the audio is output on the personal computer 1 side. Regarding this case, the user may set the smartphone 2 so as to output the audio as well as the personal computer 1 or may prevent the smartphone 2 from outputting the audio. Similarly, in case (3), out of the video and audio used for the notification for the user by various application programs 203 (other than the program which is the cause of the exclusive audio output state), the video is output on the personal computer 1 side. Regarding this case, the user may set the smartphone 2 so as to output the video as well as the personal computer 1 or may prevent the smartphone 2 from outputting the video. The setting processor 2021 provides a user interface for enabling the user to perform this type of setting. By use of the user interface, for example, the user can set the smartphone 2 so as to output only one of the video and the audio in case (1).

In case (2), when audio output from the smartphone 2 is prevented in the setting, the notification processor 2023 prepares a message for the smartphone 2 to cause the smartphone 2 to output the video only and transmits the message to the smartphone 2. In case (3), when video output from the smartphone 2 is prevented in the setting, the notification processor 2023 prepares a message for the smartphone 2 to cause the smartphone 2 to output the audio only and transmits the message to the smartphone 2.

As stated above, here, it is assumed that a notification is transmitted from the personal computer 1 to the smartphone 2 through wireless communication conforming to the Bluetooth (registered trademark) standard. In this case, pairing is performed between the personal computer 1 and the smartphone 2. At the time of pairing, the personal computer 1 is capable of obtaining various types of information from the smartphone 2. As one of these types of information, the personal computer 1 is capable of obtaining the presence or absence of the video output function and the presence or absence of the audio output function. Thus, even when a device which has one of the video output function and the audio output function is employed as an external device instead of a device which has both the video output function and the audio output function such as the smartphone 2, the personal computer 1 is capable of adaptively transmitting an appropriate message in accordance with the presence or absence of the video output function and the presence or absence of the audio output function of the external device as shown in FIG. 8.

When the external device has the video output function only, the notification processor 2023 prepares a message for the external device to cause the external device to output video only and transmits the message to the smartphone 2. When the external device has the audio output function only, the notification processor 2023 prepares a message for the external device to cause the external device to output audio only and transmits the message to the smartphone 2. Naturally, regardless of the presence or absence of the video output function and the presence or absence of the audio output function, the notification processor 2023 may always prepare a message for the external device to cause the external device to output video and audio, and transmit the message to the smartphone 2.

Even when a device which has both the video output function and the audio output function, such as the smartphone 2, is employed as the external device, an inquiry may be made to the external device regarding whether or not the video output can be performed in the current state and whether or not the audio output can be performed in the current state every time the transmission of a message is needed. In accordance with the response to the inquiry, an appropriate message may be adaptively prepared and be transmitted to the external device.

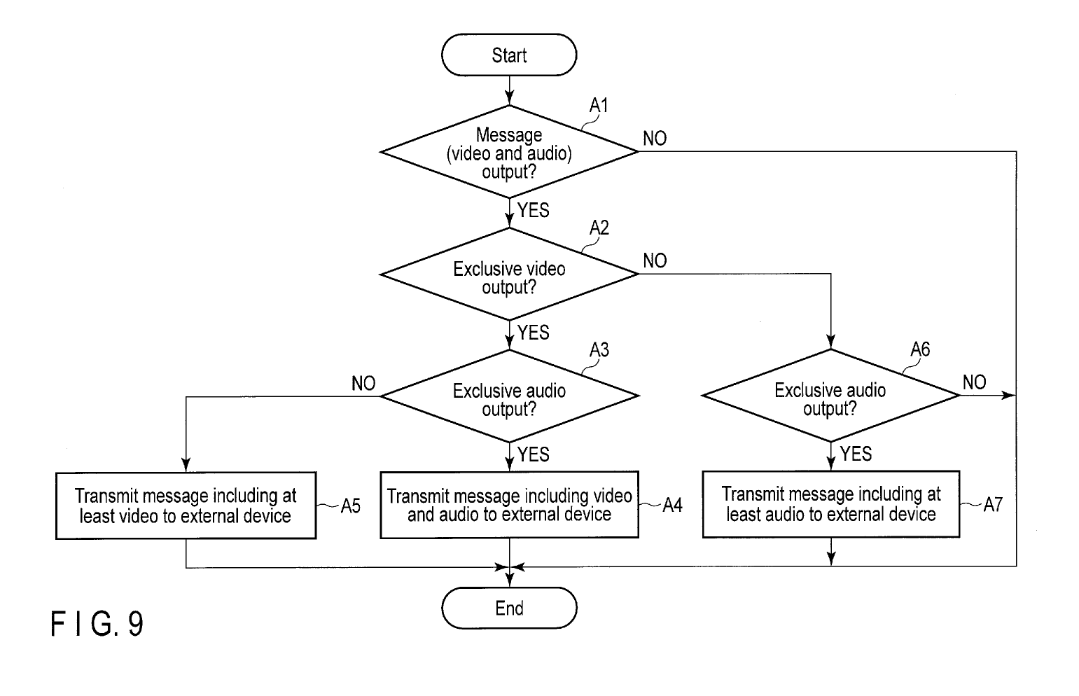

FIG. 9 is an exemplary flowchart showing the flow of the transmission of a message to the smartphone 2 by the message notification utility program 202 running on the personal computer 1.

When the notification (message output) for the user of the personal computer 1 with video and audio is performed by various application programs 203 (YES in block A1), the message notification utility program 202 determines whether or not the personal computer 1 is currently performing exclusive video output (block A2). When the personal computer 1 is currently performing exclusive video output (YES in block A2), the message notification utility program 202 determines whether or not the personal computer 1 is currently performing exclusive audio output (block A3). When the personal computer 1 is currently performing exclusive audio output (YES in block A3), the message notification utility program 202 transmits a message including the video and the audio to the smartphone 2 (block A4). When the personal computer 1 is currently performing exclusive video output and is not currently performing exclusive audio output (NO in block A3), the message notification utility program 202 transmits a message including at least the video to the smartphone (block AS).

Even when the personal computer 1 is not currently performing exclusive video output (NO in block A2), the message notification utility program 202 determines whether or not the personal computer 1 is currently performing exclusive audio output (block A6). When the personal computer 1 is currently performing exclusive audio output (YES in block A6), the message notification utility program 202 transmits a message including at least the audio to the smartphone 2 (block A7). When the personal computer 1 is currently performing neither exclusive video output nor exclusive audio output (NO in block A6), both the video output and the audio output are performed in the personal computer 1. Therefore, the message notification utility program 202 does not transmit a message to the smartphone 2.

In the present embodiment, even in a state where the personal computer 1 is in at least one of the exclusive video output state and the exclusive audio output state because of an application program, a notification for the user of the personal computer 1 by another application program is assuredly realized by an external device.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display device;
an audio output device;
a communication device; and
a hardware processor configured to transmit information for a notification of a second program including at least one of video and audio to an external device by use of the communication device, if the notification for a user of the electronic device with the video and the audio is performed by the second program in a state where at least one of exclusive video output from the display device and exclusive audio output from the audio output device is performed due to a first program.

2. The electronic device of claim 1, wherein the hardware processor is configured to obtain information for determining whether or not the display device is in an exclusive video output state, from a display driver which controls the display device.

3. The electronic device of claim 1, wherein the hardware processor is configured to obtain information for determining whether or not the audio output device is in an exclusive audio output state, from a sound driver which controls the audio output device.

4. The electronic device of claim 1, wherein the hardware processor is configured to determine that exclusive video output is performed in the display device and exclusive audio output is performed in the audio output device, if the first program reproduces high-definition video.

5. The electronic device of claim 1, wherein the hardware processor is configured to determine that exclusive video output is performed in the display device, if the first program performs full-screen display.

6. The electronic device of claim 1, wherein the hardware processor is configured to determine a target to be transmitted to the external device from the audio and the video used for the notification of the second program in accordance with a video output state of the display device and an audio output state of the audio output device.

7. The electronic device of claim 6, wherein the hardware processor is configured to receive setting for determining the target to be transmitted to the external device.

8. The electronic device of claim 1, wherein the hardware processor is configured to determine a target to be transmitted to the external device from the audio and the video used for the notification of the second program in accordance with whether or not video output and audio output are allowed in the external device.

9. The electronic device of claim 1, wherein the hardware processor comprises means for transmitting information for the notification of the second program including at least one of video and audio to an external device by use of the communication device, if the notification for the user of the electronic device with video and audio is performed by the second program in the state where at least one of exclusive video output from the display device and exclusive audio output from the audio output device is performed because of the first program.

10. An electronic device comprising:
a display device;
an audio output device;
a communication device; and
a hardware processor configured to receive information for a notification for a user of the electronic device including at least one of video and audio from an external device by use of the communication device, and to perform at least one of output of the video by the display device and output of the audio by the audio output device.

11. A method for an electronic device, the method comprising:
transmitting information for a notification of a second program including at least one of video and audio to an external device, if the notification for a user of the electronic device with the video and the audio is performed by the second program in a state where at least one of exclusive video output and exclusive audio output is performed due to a first program.

12. The method of claim 11, further comprising obtaining information for determining whether or not a state is an exclusive video output state, from a display driver which controls video output.

13. The method of claim 11, further comprising obtaining information for determining whether or not a state is an exclusive audio output state, from a sound driver which controls audio output.

14. The method of claim 11, further comprising determining that exclusive video output and exclusive audio output are performed, if the first program reproduces high-definition video.

15. The method of claim 11, further comprising determining that exclusive video output is performed, if the first program performs full-screen display.

16. The method of claim 11, further comprising determining a target to be transmitted to the external device from the audio and the video used for the notification of the second program in accordance with a video output state and an audio output state.

17. The method of claim 16, further comprising receiving setting for determining the target to be transmitted to the external device.

18. The method of claim 11, further comprising determining a target to be transmitted to the external device from the audio and the video used for the notification of the second program in accordance with whether or not video output and audio output are allowed in the external device.
